(19) United States
(12) Patent Application Publication
(10) Pub. No.: US 2026/0361191 A1
(43) Pub. Date: Nov. 12, 2026

(54) AN ELECTRICAL MACHINE AND A METHOD FOR IMPLEMENTING A TRANSPORTATION SUPPORT OF THE SAME

(71) Applicant: Danfoss A/S, Nordborg (DK)

(72) Inventors: Tomi KNUUTILA, Kuukanniemi (FI); Aki LIPPONEN, Lappeenranta (FI); Aki NORDVALL, Helsinki (FI); Mikko OVASKA, Lappeenranta (FI)

(21) Appl. No.: 19/136,139

(22) PCT Filed: Nov. 10, 2023
(86) PCT No.: PCT/EP2023/081394

§ 371 Date: Jun. 5, 2025

(30) Foreign Application Priority Data
Dec. 8, 2022 (EP) 22212319.2

(51) Int. Cl. H02K 15/60; F16C 39/02

(52) U.S. Cl. CPC H02K 15/60; F16C 39/02

(57) ABSTRACT

An electrical machine includes a stator (101), a rotor (102), and bearings (103) configured to rotatably support the rotor with respect to the stator. The electrical machine includes a force generating device (104) attached to the stator and including an actuator (105) for directing an axial force to an end of a shaft (106) of the rotor. The actuator can be hydraulically, pneumatically, or electrically driven. While the electrical machine is transported by using for example a trailer, truck, locomotive, or ship and transportation support is needed, the actuator is controlled to direct the axial force to the end of a shaft to remove clearances from the bearings and thereby to protect the bearings against damaging during the transportation. While the electrical machine is used for its purpose as a motor or generator, there is advantageously a physical air gap between the actuator and the end of the shaft.

### CROSS-REFERENCE TO RELATED APPLICATIONS

This application is a National Stage application of International Patent Application No. PCT/EP2023/081394, filed on Nov. 10, 2023, which claims priority to European Patent Application No. 22212319.2, filed on Dec. 8, 2022, each of which is hereby incorporated by reference in its entirety.

### TECHNICAL FIELD

The disclosure relates generally to electrical machines. More particularly, the disclosure relates to an electrical machine that comprises a stator, a rotor, bearings configured to rotatably support the rotor with respect to the stator, and means for implementing a transportation support for protecting the electrical machine against damaging when the electrical machine is transported or is otherwise subject to external vibrations and/or impacts at standstill. Furthermore, the disclosure relates to a method for implementing a transportation support of an electrical machine. Furthermore, the disclosure relates to an electric drive.

### BACKGROUND

While an electrical machine is at standstill and the electrical machine is transported as such or as a part of an application system, such as a working machine, by using a trailer, truck, locomotive, or ship, there is a possibility to damage the bearings of the electrical machine. Especially, in large electrical machines with substantially higher rotor masses, the bearings are at a significant risk to damage due to external vibration and impacts if not properly protected. The reason for the possible damages is that all rolling element bearings have a clearance to be able to be lubricated and to rotate with a low rolling resistance. Thus, external vibration and impacts may cause situation in which bearing surfaces bang against each other and get thereby damaged.

To avoid bearing damages of the kind mentioned above, there is a need to mechanically support the rotor of an electrical machine so that bearing surfaces are prevented from banging against each other when the electrical machine is transported or is otherwise subject to external vibrations and/or impacts at standstill. Arranging a sufficient mechanical support can be especially challenging when an electrical machine is a part of an application system, such as a working machine, which is being transported or is otherwise subject to external vibrations and/or impacts.

### SUMMARY

The following presents a simplified summary to provide a basic understanding of some aspects of various embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments.

In accordance with the invention, there is provided a new electrical machine that comprises:
a stator,
a rotor rotatably supported with respect to the stator and configured to electromagnetically interact with the stator to produce torque in response to one or more electric currents supplied to the electrical machine,
bearings configured to rotatably support the rotor with respect to the stator, and
a force generating device mechanically attached to the stator and comprising an actuator configured to direct an axial force to an end of a shaft of the rotor to remove clearances from the bearings.

While the above-described electrical machine is transported or is otherwise subject to external vibrations and/or impacts at standstill, the actuator is controlled to direct axial force to the end of a shaft to remove clearances from the bearings and thereby to prevent bearing surfaces from banging against each to protect the bearings against damaging. While the electrical machine is used for its purpose as a motor or generator, the force generating device is advantageously in a mode where there is a physical air gap between the actuator and the end of the shaft.

In the above-described electrical machine, the fact that many bearings providing radial support can withstand also axial loads is utilized to support the rotor when the electrical machine is being transported or is otherwise subject to external vibrations and/or impacts at standstill. For example, rolling elements with round or convex shapes naturally remove a radial clearance when an outer race of a bearing is displaced axially from an inner race of the bearing.

The above-mentioned force generating device can be a hydraulic device where the actuator comprises a hydraulic piston. It is also possible that the force generating device is a pneumatic device having a pneumatically driven actuator or an electrical device having a magnetically driven actuator. It is to be noted that embodiments of the invention are not limited to any specific way or ways to direct an axial force to an end of a shaft of an electrical machine.

In accordance with the invention, there is also provided a new electric drive that comprises an electrical machine and a converter configured to drive the electrical machine. The electrical machine is an electrical machine according to an embodiment that comprises a status detection device configured to produce a status signal expressing whether the actuator directs an axial force to the end of the shaft of the rotor. The converter is configured to receive the status signal and to refrain from supplying voltage to the electrical machine when the actuator directs the axial force to the end of the shaft of the rotor to avoid an unintentional and possibly damaging starting of the electrical machine when the force generating device is active.

In accordance with the invention, there is also provided a new method for implementing a transportation support for an electrical machine that comprises:
a stator,
a rotor rotatably supported with respect to the stator and configured to electromagnetically interact with the stator to produce torque in response to electric current supplied to the electrical machine, and
bearings configured to rotatably support the rotor with respect to the stator.

The method according to the invention comprises directing an axial force to an end of a shaft of the rotor to remove clearances from the bearings with the aid of a force generating device mechanically attached to the stator and comprising an actuator configured to direct the axial force to the end of the shaft of the rotor.

In this document, the term “transportation support” means a support arrangement that is applicable for protecting against damages during transportation as well as during other situations in which an electrical machine is at standstill and subject to external vibrations and/or impacts.

Exemplifying and non-limiting embodiments are described in accompanied dependent claims.

Exemplifying and non-limiting embodiments both as to constructions and to methods of operation, together with additional objects and advantages thereof, will be best understood from the following description of specific exemplifying and non-limiting embodiments when read in conjunction with the accompanying drawings.

The verbs “to comprise” and “to include” are used in this document as open limitations that neither exclude nor require the existence of unrecited features.

The features recited in dependent claims are mutually freely combinable unless otherwise explicitly stated.

Furthermore, it is to be understood that the use of “a” or “an”, i.e. a singular form, throughout this document does not exclude a plurality.

### BRIEF DESCRIPTION OF THE DRAWINGS

Exemplifying and non-limiting embodiments and their advantages are explained in greater detail below in the sense of examples and with reference to the accompanying drawings, in which:

FIG. 1 illustrates an electrical machine according to an exemplifying and non-limiting embodiment,

FIG. 2 illustrates an electrical machine according to an exemplifying and non-limiting embodiment, and

FIG. 3 shows a flowchart of a method according to an exemplifying and non-limiting embodiment for implementing a transportation support for an electrical machine.

### DETAILED DESCRIPTION

The specific examples provided in the description below should not be construed as limiting the scope and/or the applicability of the accompanied claims. Lists and groups of examples provided in the description are not exhaustive unless otherwise explicitly stated.

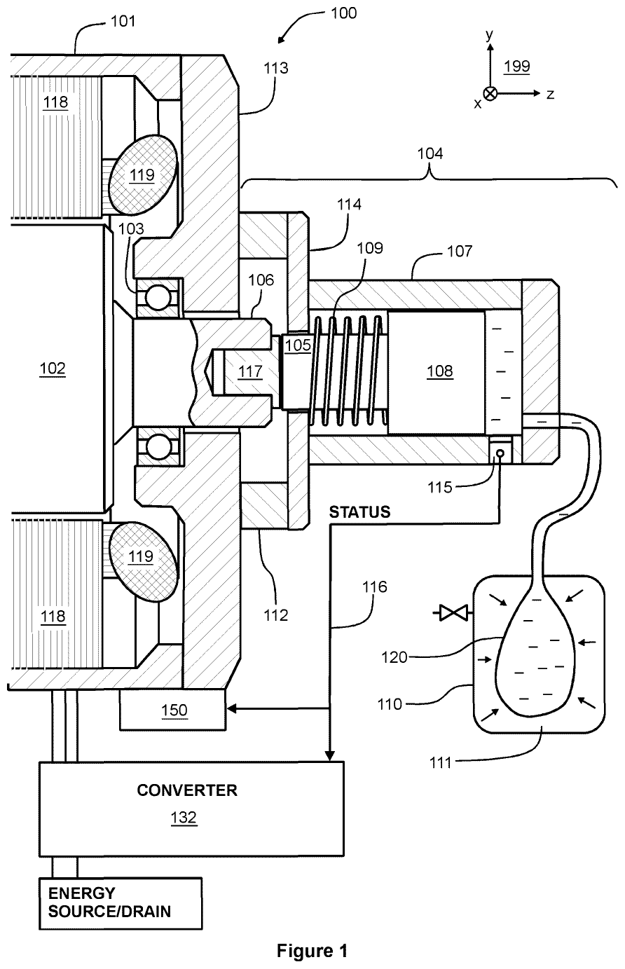

FIG. 1 illustrates a part of an electrical machine 100 according to an exemplifying and non-limiting embodiment. The electrical machine 100 comprises a stator 101 and a rotor 102 that is rotatably supported with respect to the stator 101 and configured to electromagnetically interact with the stator to produce torque in response to currents supplied to the electrical machine. The electrical machine 100 can be for example an induction machine, a permanent magnet machine, a reluctance machine, or direct current “DC” machine. In FIG. 1, only the non-driving “ND” end of the electrical machine 100 is shown. The stator 101 is shown as a section view where the geometric section plane is parallel with the yz-plane of a coordinate system 199. The stator 102 comprises a stator core structure 118 and stator windings 119. The axial direction of the electrical machine 100 is parallel with the z-axis of the coordinate system 199. The electrical machine 100 comprises bearings configured to rotatably support the rotor 102 with respect to the stator 101. In FIG. 1, the bearing of the ND-end is denoted with a reference 103. In this exemplifying case, the bearing 103 is a ball bearing. Correspondingly, the bearing of the driving “D” end of the electrical machine 100 can be a ball bearing. The bearing of the D-end is not shown in FIG. 1.

The electrical machine 100 comprises a force generating device 104 that is mechanically attached to the stator 101 and comprises an actuator 105 configured to direct an axial force to an end of a shaft 106 of the rotor 102 to remove clearances from the bearings of the electrical machine 100. In FIG. 1, the end of the shaft 106 is shown as a section view where the geometric section plane is parallel with the yz-plane of the coordinate system 199. In this exemplifying case, the force generating device is at the ND-end of the electrical machine. It is however also possible that a force generating device is configured to direct an axial force to an end of a shaft at the D-end of the electrical machine. For example, there can be a gearwheel or a sheave attached to the end of the shaft of an electrical machine, and the force generating device is configured to direct an axial force to the end of the shaft that protrudes through the gearwheel or the sheave.

In the exemplifying electrical machine 100 illustrated in FIG. 1, the force generating device 104 is a hydraulic device that comprises a hydraulic cylinder 107 and the actuator 105 of the force generating device 104 comprises a hydraulic piston 108. In FIG. 1, the hydraulic cylinder 107 is shown as a section view where the geometric section plane is parallel with the yz-plane of the coordinate system 199. In this exemplifying case, the hydraulic cylinder 107 is a single-action hydraulic cylinder capable of pushing the hydraulic piston 108 towards the end of the shaft 106 of the rotor in the negative z-direction of the coordinate system 199. The force generating device 104 comprises a return spring 109 configured to push the hydraulic piston away from the end of the shaft 106 of the rotor in the positive z-direction of the coordinate system 199. It is also possible that a force generating device of an electrical machine according to an exemplifying and non-limiting embodiment is an electromagnetic device comprising an electromagnet for generating an axial force directed to an end of a shaft of the electrical machine. Furthermore, it is also possible that a force generating device of an electrical machine according to an exemplifying and non-limiting embodiment is a pneumatic device comprising a pneumatically driven actuator for generating an axial force directed to an end of a shaft of the electrical machine.

In the exemplifying electrical machine 100 illustrated in FIG. 1, the force generating device 104 comprises a pressurizer 110 that is capable of maintaining pressure of hydraulic fluid without external energy for example when the electrical machine 100 is transported or is otherwise subject to external vibrations and/or impacts and no external energy is available. In this exemplifying case, the pressurizer 110 comprises a body and a flexible bag 120 inside the body and containing the hydraulic fluid. The force generating device 104 is activated by pumping compressed flexible material 111, e.g. air or other gas, into the room between the body and the flexible bag 120. The flexible material 111 directs pressure to the flexible bag 120 and thereby maintains the pressure of hydraulic fluid. The force generating device 104 is deactivated by allowing the pressure of the flexible material 111 to drop down. Depending on requirements and availability or non-availability of external energy, different means for controlling the force generating device 104 are possible, e.g. an electrically driven hydraulic pump, a spring operated pressurizer, etc.

In the exemplifying electrical machine 100 illustrated in FIG. 1, the force generating device 104 comprises a collar section 112 attached to a bearing shield 113 of the electrical machine 100 and a flange section 114 connecting to the collar section. In FIG. 1, the collar section 112 and the flange section 114 are shown as section views where the geometric section plane is parallel with the yz-plane of the coordinate system 199. The hydraulic cylinder 107 is attached to the flange section 114 and the actuator 105 protrudes towards the end of the shaft 106 of the rotor via an aperture of the flange section 114.

The exemplifying electrical machine 100 illustrated in FIG. 1 comprises a protector element 117 between the actuator 105 of the force generating device 104 and the end of the shaft 106 of the rotor. In FIG. 1, the protector element 117 is shown as a section view where the geometric section plane is parallel with the yz-plane of the coordinate system 199. The protector element 117 is made of material softer than material of the shaft 106 of the rotor and protects the shaft of the rotor from shape deformations. The protector element 117 can be made of e.g. aluminum or nylon.

An electrical machine according to an exemplifying and non-limiting embodiment comprises a status detection device 115 configured to produce a status signal 116 that directly or indirectly expresses whether the actuator 105 directs an axial force to the end of the shaft 106 of the rotor 102. In the exemplifying electrical machine illustrated in FIG. 1, the status detection device 115 comprises a pressure sensor configured to detect the pressure of the hydraulic fluid and to produce the status signal 116 in accordance with the detected pressure. It is also possible that the status detection device of an electrical machine according to an exemplifying and non-limiting embodiment comprises a position sensor configured to detect the axial position of the actuator of the force generating device, or a mechanical sensor such as a strain gauge configured to detect mechanical stress or deformation in the actuator or in some other appropriate part of the force generating device. In an exemplifying case, where the force generating device is an electromagnetic force generating device, the status detection device may comprise a device for generating the status signal based on electric current of the electromagnetic force generating device. In an exemplifying case, where the force generating device is a pneumatic force generating device, the status detection device may comprise e.g. a gas pressure sensor or a device for generating the status signal based on operation of means for supplying pressurized gas e.g. air to the pneumatic force generating device. It is to be noted that the above-mentioned status signal can be produced in many ways, and the embodiments of the invention are not limited to any specific way or ways to produce the status signal.

The above-mentioned status signal 116 is advantageous in an electric drive that comprises the electrical machine 100 and a converter 132 configured to drive the electrical machine 100. The converter 132 is configured to receive the status signal 116 and to refrain from supplying voltage to the electrical machine 100 when the actuator 105 directs the axial force to the end of the shaft 106 to avoid an unintentional and possibly damaging starting of the electrical machine 100 when the force generating device 104 is active.

Furthermore, the status signal 116 can be used as a feedback signal supplied to a control device that is configured to control the force generating device. The feedback signal can be used for e.g. monitoring that the force generating device works correctly in response to control actions carried out by the control device. Concealed incorrect operation of the force generating device may lead to bearing damages during transportation as well as during other situations in which the electrical machine is at standstill and subject to external vibrations and/or impacts. The feedback signal can be used for generating an alarm in a case of incorrect operation of the force generating device. An electrical machine according to an exemplifying and non-limiting embodiment comprises a control device 150 configured to control the force generating device, to receive the status signal 116, and to generate an alarm in response to a situation in which i) the force generating device has been controlled to direct the axial force to the end of the shaft but ii) the status signal 116 expresses that no axial force is directed to the end of the shaft.

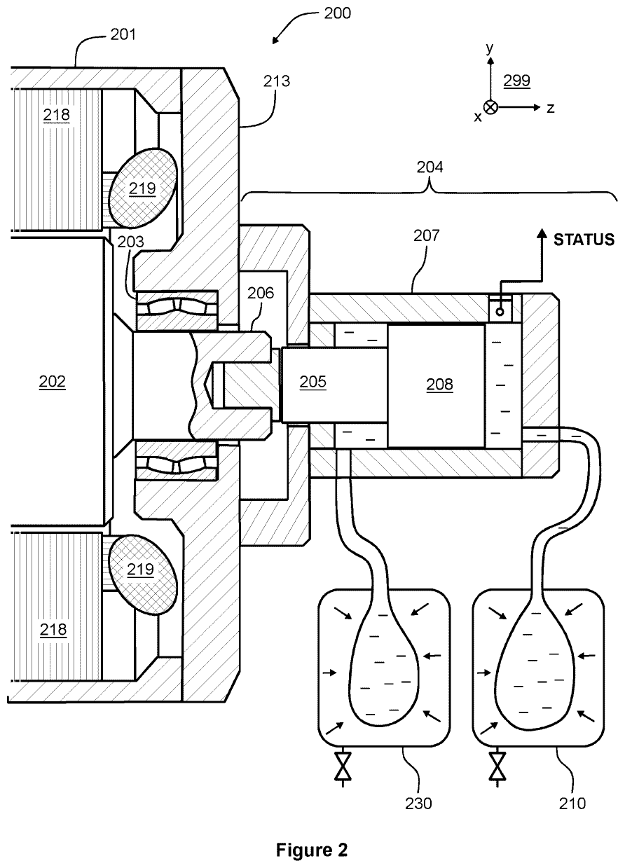

FIG. 2 illustrates a part of an electrical machine 200 according to an exemplifying and non-limiting embodiment. The electrical machine 200 comprises a stator 201 and a rotor 202 that is rotatably supported with respect to the stator 201 and configured to electromagnetically interact with the stator to produce torque in response to currents supplied to the electrical machine. In FIG. 2, only the non-driving “ND” end of the electrical machine 200 is shown. The stator 201 is shown as a section view where the geometric section plane is parallel with the yz-plane of a coordinate system 299. The stator 202 comprises a stator core structure 218 and stator windings 219. The axial direction of the electrical machine 200 is parallel with the z-axis of the coordinate system 299. The electrical machine 200 comprises bearings configured to rotatably support the rotor 202 with respect to the stator 201. In FIG. 2, the bearing of the ND-end is denoted with a reference 203. In this exemplifying case, the bearing 203 is a spherical roller bearing. Correspondingly, the bearing of the driving “D” end of the electrical machine 200 can be a spherical roller bearing. The bearing of the D-end is not shown in FIG. 2.

The electrical machine 200 comprises a force generating device 204 that is mechanically attached to the stator 201 and comprises an actuator 205 configured to direct an axial force to an end of a shaft 206 of the rotor 202 to remove clearances from the bearings of the electrical machine 200. In FIG. 2, the end of the shaft 206 is shown as a section view where the geometric section plane is parallel with the yz-plane of the coordinate system 299. In this exemplifying case, the force generating device is at the ND-end of the electrical machine. The force generating device 204 comprises a hydraulic cylinder 207 and the actuator 205 of the force generating device comprises a hydraulic piston 208. In FIG. 2, the hydraulic cylinder 207 is shown as a section view where the geometric section plane is parallel with the yz-plane of the coordinate system 299. In this exemplifying case, the hydraulic cylinder 207 is a double-action hydraulic cylinder capable of pushing the hydraulic piston 208 towards the end of the shaft 206 of the rotor in the negative z-direction of the coordinate system 299, and capable of moving the hydraulic piston away from the end of the shaft of the rotor in the positive z-direction of the coordinate system 299.

In the exemplifying electrical machine 200 illustrated in FIG. 2, the force generating device 204 comprises pressurizers 210 and 230 which are capable of maintaining pressures of hydraulic fluids in different compartments of the hydraulic cylinder 207 without external energy. In this exemplifying case, each of the pressurizers 210 and 230 comprises a body and a flexible bag inside the body and containing the hydraulic fluid.

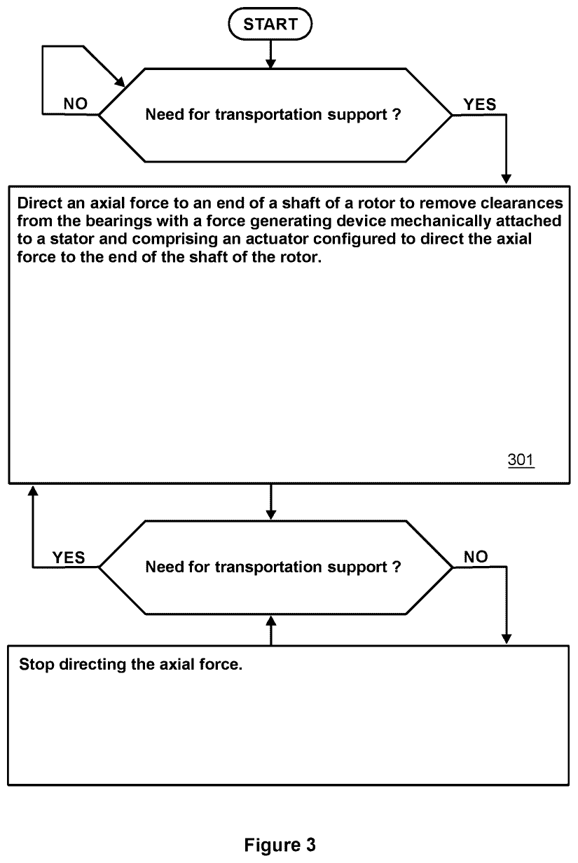

FIG. 3 shows a flowchart of a method according to an exemplifying and non-limiting embodiment for implementing a transportation support for an electrical machine that comprises a stator, a rotor rotatably supported with respect to the stator and configured to electromagnetically interact with the stator to produce torque in response to electric current supplied to the electrical machine, and bearings configured to rotatably support the rotor with respect to the stator.

The method comprises directing 301 an axial force to an end of a shaft of the rotor to remove clearances from the bearings with the aid of a force generating device mechanically attached to the stator and comprising an actuator configured to direct the axial force to the end of the shaft of the rotor.

In a method according to an exemplifying and non-limiting embodiment, the force generating device comprises a hydraulic cylinder and the actuator of the force generating device comprises a hydraulic piston.

In a method according to an exemplifying and non-limiting embodiment, the hydraulic cylinder is a double-action hydraulic cylinder capable of pushing the hydraulic piston towards the end of the shaft of the rotor and capable of moving the hydraulic piston away from the end of the shaft of the rotor.

In a method according to an exemplifying and non-limiting embodiment, the hydraulic cylinder is a single-action hydraulic cylinder capable of pushing the hydraulic piston towards the end of the shaft of the rotor, and the force generating device comprises a return spring configured to push the hydraulic piston away from the end of the shaft of the rotor.

A method according to an exemplifying and non-limiting embodiment comprises maintaining pressure of hydraulic fluid with an aid of flexible material, e.g. air, being compressed and tending to return to an uncompressed state.

A method according to an exemplifying and non-limiting embodiment comprises use of a protector element between the actuator of the force generating device and the end of the shaft of the rotor. The protector element is made of material, e.g. aluminum or nylon, softer than material of the shaft of the rotor and protects the shaft of the rotor from shape deformations.

A method according to an exemplifying and non-limiting embodiment comprises:
producing a status signal expressing whether the actuator directs the axial force to the end of the shaft of the rotor,
delivering the status signal to a converter configured to drive the electrical machine, and
disabling the converter to supply voltage to the electrical machine when the status signal expresses that the actuator directs the axial force to the end of the shaft of the rotor.

A method according to an exemplifying and non-limiting embodiment comprises producing the status signal expressing whether the actuator directs the axial force to the end of the shaft of the rotor, and generating an alarm in response to a situation in which i) the force generating device has been controlled to direct the axial force to the end of the shaft but ii) the status signal expresses that no axial force is directed to the end of the shaft.

The specific examples provided in the description given above should not be construed as limiting the applicability and/or interpretation of the appended claims. It is to be noted that lists and groups of examples given in this document are non-exhaustive lists and groups unless otherwise explicitly stated.

While the present disclosure has been illustrated and described with respect to a particular embodiment thereof, it should be appreciated by those of ordinary skill in the art that various modifications to this disclosure may be made without departing from the spirit and scope of the present disclosure.

1. An electrical machine comprising:
a stator,
a rotor rotatably supported with respect to the stator and configured to electromagnetically interact with the stator to produce torque in response to one or more electric currents supplied to the electrical machine, and
bearings configured to rotatably support the rotor with respect to the stator, wherein
the electrical machine further comprises a force generating device mechanically attached to the stator and comprising an actuator configured to direct an axial force to an end of a shaft of the rotor to remove clearances from the bearings.

2. The electrical machine according to claim 1, wherein the force generating device comprises a hydraulic cylinder and the actuator of the force generating device comprises a hydraulic piston.

3. The electrical machine according to claim 2, wherein the hydraulic cylinder is a double-action hydraulic cylinder capable of pushing the hydraulic piston towards the end of the shaft of the rotor and capable of moving the hydraulic piston away from the end of the shaft of the rotor.

4. The electrical machine according to claim 2, wherein the hydraulic cylinder is a single-action hydraulic cylinder capable of pushing the hydraulic piston towards the end of the shaft of the rotor, and the force generating device comprises a return spring configured to push the hydraulic piston away from the end of the shaft of the rotor.

5. The electrical machine according to claim 2, wherein the force generating device comprises a pressurizer configured maintain pressure of hydraulic fluid with an aid of flexible material being compressed and tending to return to an uncompressed state.

6. The electrical machine according to claim 2, wherein the force generating device comprises a collar section attached to a bearing shield of the electrical machine and a flange section connecting to the collar section, the hydraulic cylinder being attached to the flange section and the actuator protruding towards the end of the shaft of the rotor via an aperture of the flange section.

7. The electrical machine according to claim 1, wherein the electrical machine comprises a protector element between the actuator of the force generating device and the end of the shaft of the rotor, the protector element being made of material softer than material of the shaft of the rotor and protecting the shaft of the rotor from shape deformations.

8. The electrical machine according to claim 1, wherein the electrical machine comprises a status detection device configured to produce a status signal expressing whether the actuator directs the axial force to the end of the shaft of the rotor.

9. The electrical machine according to claim 8, wherein the electrical machine comprises a control device configured to control the force generating device, to receive the status signal, and to generate an alarm in response to a situation in which i) the force generating device has been controlled to direct the axial force to the end of the shaft but ii) the status signal expresses that no axial force is directed to the end of the shaft.

10. An electric drive that comprises:
an electrical machine, and
a converter configured to drive the electrical machine,
wherein the electrical machine is an electrical machine according to claim 8, and the converter is configured to receive the status signal and to refrain from supplying voltage to the electrical machine when the status signal expresses that the actuator directs the axial force to the end of the shaft of the rotor.

11. A method for implementing a transportation support for an electrical machine that comprises:
a stator,
a rotor rotatably supported with respect to the stator and configured to electromagnetically interact with the stator to produce torque in response to electric current supplied to the electrical machine, and
bearings configured to rotatably support the rotor with respect to the stator,
wherein the method comprises directing an axial force to an end of a shaft of the rotor to remove clearances from the bearings with a force generating device mechanically attached to the stator and comprising an actuator configured to direct the axial force to the end of the shaft of the rotor.

12. The method according to claim 11, wherein the force generating device comprises a hydraulic cylinder and the actuator of the force generating device comprises a hydraulic piston.

13. The method according to claim 12, wherein the hydraulic cylinder is a double-action hydraulic cylinder capable of pushing the hydraulic piston towards the end of the shaft of the rotor and capable of moving the hydraulic piston away from the end of the shaft of the rotor.

14. The method according to claim 13, wherein the hydraulic cylinder is a single-action hydraulic cylinder capable of pushing the hydraulic piston towards the end of the shaft of the rotor, and the force generating device comprises a return spring configured to push the hydraulic piston away from the end of the shaft of the rotor.

15. The method according to claim 12, wherein the method comprises maintaining pressure of hydraulic fluid with an aid of flexible material being compressed and tending to return to an uncompressed state.

16. The method according to claim 11, wherein the method comprises use of a protector element between the actuator of the force generating device and the end of the shaft of the rotor, the protector element being made of material softer than material of the shaft of the rotor and protecting the shaft of the rotor from shape deformations.

17. The method according to claim 11, wherein the method comprises:
producing a status signal expressing whether the actuator directs the axial force to the end of the shaft of the rotor,
delivering the status signal to a converter configured to drive the electrical machine, and
disabling the converter to supply voltage to the electrical machine when the status signal expresses that the actuator directs the axial force to the end of the shaft of the rotor.
